(19) United States
(12) Patent Application Publication
(10) Pub. No.: US 2025/0321565 A1
(43) Pub. Date: Oct. 16, 2025

(54) SYSTEM AND METHOD FOR MACHINE SPEED MANAGEMENT

(71) Applicant: Caterpillar Inc., Peoria, IL (US)

(72) Inventors: Russell Allen BROCKHURST, Carindale (AU); Kenneth Patrick ROBINSON, Brisbane (AU)

(73) Assignee: Caterpillar Inc., Peoria, IL (US)

(21) Appl. No.: 18/634,090

(22) Filed: Apr. 12, 2024

(51) Int. Cl. G05B 19/4155

(52) U.S. Cl. CPC G05B 19/4155; G05B 2219/31412

(57) ABSTRACT

In some implementations, a controller may obtain a production plan for a work environment, the production plan including at least one production circuit for machines, wherein the at least one production circuit is based on respective production parameters. The controller may determine cycle times for respective production circuits of the at least one production circuit, wherein the cycle times are based on at least one machine performance parameter. The controller may perform an action associated with controlling a speed of a first machine based on a cycle time of a first production circuit in which the first machine is operating and based on at least one dynamic event in the work environment.

### TECHNICAL FIELD

The present disclosure relates generally to machines and, more particularly, to A system and method for machine speed management.

### BACKGROUND

Machines may be deployed in a work environment, such as a mine site, among other examples. For example, the machines may be deployed to transport aggregate material, such as ore, from a mining site to a processing or shipping facility. Typical mining operations use guided haul trucks that carry the extracted material from an extraction area or material source to a deposition area or a material sink. A typical large scale mining operation may include more than one material source and more than one material sink. The haul trucks used to transport the material may be autonomously guided, i.e., operate without a driver, and may perform hundreds of trips daily as some mining operations operate around the clock. The loading of the aggregate material onto the haul trucks is typically accomplished by use of machines, such as wheel loaders or excavators, material conveyors, and/or shovels, among other examples.

For many large work environments, maximization of equipment utilization is desired. The maximization of equipment utilization, especially in the case of autonomously guided vehicles, requires efficient dispatching of the haul trucks to the various loading and unloading stations. In some examples, a machine may be associated with one or more parameters which may limit or restrict a usage of the machine. As an example, the one or more parameters may include a tire heat, one or more battery parameters, e.g., for machines that are include one or more batteries, such as for electric or hybrid machines, and/or one or more fuel usage parameters. For example, the tires of a machine may be configured to operate under a certain temperature. If the temperature of the tires becomes too high, then there is an increased risk of damage or failure of the tire. Therefore, to ensure that the temperature of the tires of a machine does not become too high, the speed of the machine may be limited or reduced.

In some examples, machine speed may be managed to ensure that the one or more parameters are satisfied or met. For example, machine speed may be managed for particular machines, e.g., on a per-machine basis. For example, a machine may include one or more sensors or system to monitor the temperature of the tires of the machine. If the temperature of the tires is greater than or equal to a temperature threshold, then the speed of the machine may be reduced. However, the work environment in which the machine is operating may include multiple machines traveling on shared roads or tracks. As a result, reducing the speed of the machine may cause other machines traveling on the same road or track, e.g., that are following or traveling behind the machine, to also reduce their speed, e.g., even if the parameter(s), such as tire heat, of the other machines are met or satisfied. This per-machine basis speed management result in inefficient operation for the other machines and/or the work environment as a whole.

For example, while reducing the speed of a given machine may ensure that the one or more parameters are met or satisfied for that machine, this may result in reducing a speed of other machines that are traveling behind the machine where the other machines could otherwise be traveling at a faster speed. The reduction in speed of the machines may reduce the production and/or efficiency of the entire work environment, e.g., may reduce a productivity of an entire mining site.

In other examples, machine speed may be managed in a centralized manner using an assignment operation. The assignment operation may include determinations of a next task for a given machine based on a current operating state of the given machine, e.g., taking into account current values for the one or more parameters, such as a current tire temperature of the given machine. However, this machine speed management mechanism is reactive to the current operating state of the machines and may only take action to address values of the one or more parameters until after the values are at, or near, threshold or other criteria for the one or more parameters. As a result, a production efficiency of the machines may be reduced because the assignment operation may only be for a next task which may result in a given machine being placed in an operating state where there are no effective or efficient options for tasks for the machine, such as due to an amount of work done by the machine causing an increase in tire heat of the machine, e.g., resulting in the machine having to be out of operation or traveling at very low speeds to reduce the tire heat. Further, the assignment operation may use large amounts of data, e.g., real-time data or near real-time data, increasing the complexity and/or consuming processing resources, computing resources, and/or memory resources, among other examples, associated with performing the assignment operation.

U.S. Pat. No. 10,533,866, hereinafter the '866 patent, discloses a system configured to dispatch vehicles within a mining environment in such a manner as to take the effect of operational decisions on tire conditioning into consideration. This generally involves the continual monitoring and assessment of tire health so that incipient failures may be identified prior to reaching critical states. By analyzing those movements and the vehicle's assigned tasks, and taking into consideration other constraints a dispatch system disclosed by '866 patent can identify optimized routes and assignments to achieve desired tire wear in the vehicles in view of existing productivity constraints. The dispatch system disclosed by '866 patent may instruct vehicles to adopt different speed profiles, carry a modified load, i.e., either more or less materials, travel along a different route, or undertake a different task, which may include stopping for a period of time or traveling to a particular vehicle shop for the implementation of repairs or maintenance.

However, the system disclosed by '866 patent only considers information associated with a single vehicle. This results in reduced production and/or inefficiencies for a work environment that includes multiple work vehicles.

The system of the present disclosure solves one or more of the problems set forth above and/or other problems in the art.

### SUMMARY

A system for managing machine speed may include at least one controller configured to: obtain a production plan for a work environment, the production plan including at least one production circuit for machines, wherein the at least one production circuit is based on respective production parameters; determine cycle times for respective production circuits of the at least one production circuit, wherein the cycle times are based on at least one machine performance parameter; and perform an action associated with controlling a speed of a first machine based on a cycle time of a first production circuit in which the first machine is operating and based on at least one dynamic event in the work environment.

A method for managing machine speed may include obtaining, by a controller, a production plan for a work environment, the production plan including at least one production circuit for machines, wherein the at least one production circuit is based on respective production parameters; determining, by the controller, cycle times for respective production circuits of the at least one production circuit, wherein the cycle times are based on at least one machine performance parameter; and performing, by the controller, an action associated with controlling a speed of a first machine based on a cycle time of a first production circuit in which the first machine is operating and based on at least one dynamic event in the work environment.

A non-transitory computer-readable medium storing a set of instructions may include at least one instruction that, when executed by at least one processor of a controller, cause the controller to: obtain a production plan for a work environment, the production plan including at least one production circuit for machines, wherein the at least one production circuit is based on respective production parameters; determine cycle times for respective production circuits of the at least one production circuit, wherein the cycle times are based on at least one machine performance parameter; and perform an action associated with controlling a speed of a first machine based on a cycle time of a first production circuit in which the first machine is operating and based on at least one dynamic event in the work environment.

### BRIEF DESCRIPTION OF DRAWINGS

FIG. 1 is a diagram of an example work environment associated with machine speed management described herein.

FIG. 2 is a diagram of an example associated with machine speed management described herein.

FIG. 3 is a diagram of an example associated with a dynamic event described herein.

FIG. 4 is a flowchart of an example process associated with machine speed management described herein.

### DETAILED DESCRIPTION

This disclosure relates to a system for managing machine speed, which is applicable to any machine. For example, the machine described herein may be a vehicle, a load-haul-dump (LHD) loader, a mining truck, e.g., an underground mining truck, an articulated truck, a material loader, e.g., a material handler, a material conveyer, a backhoe loader, a wheel loader, a harvester, an excavator, a motor grader, a skid steer loader, a tractor, a compactor machine, a paving machine, a cold planer, a dragline, a drill, a mining shovel, a forest machine, a pipelayer, a grading machine, and/or a dozer, among other examples.

For example, the machine described herein may be any machine configured to transport material. In some example, the machine(s) described herein may be deployed in a work environment, e.g., a work area. Some examples described herein may use a mining site as an example work environment. However, the techniques and implementations described herein are similarly applicable to other work environments, such as a construction site, a factory, e.g., a warehouse or distribution center, a port or shipping yard, a manufacturing plant, and/or an agricultural site, among other examples.

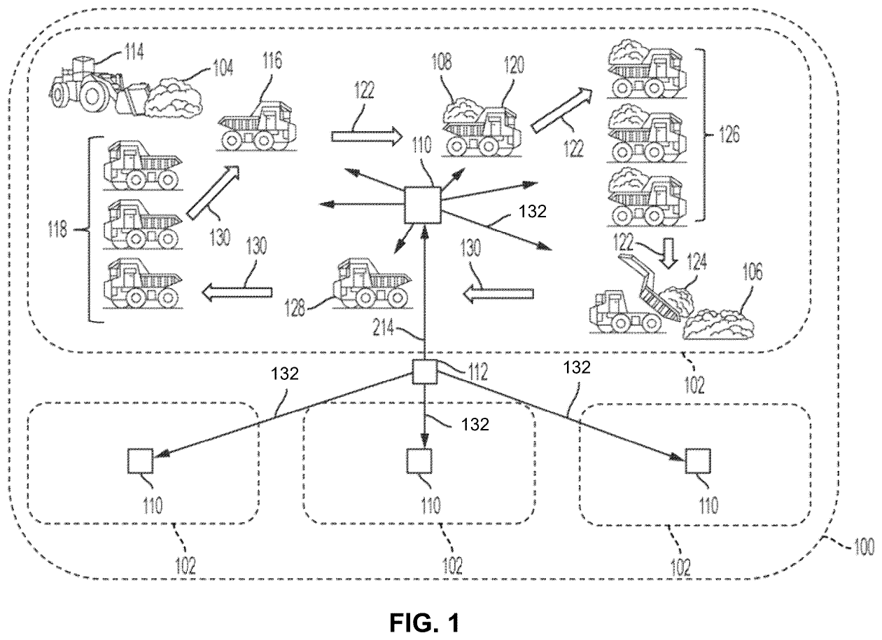

FIG. 1 is a diagram of an example work environment 100 associated with machine speed management. The diagram of the work environment 100 is a schematic view of the work environment 100. The work environment 100 is depicted as a mining site as an example.

The work environment 100 may include one or more production circuits 102. A production circuit 102 may include one or more production sites 104, one or more dump sites 106, and one or more machines 108 traveling between the production site(s) 104 and the dump site(s) 106. Depending on the material being produced, each production circuit 102 may exclusively include respective production site(s) 104 and the dump site(s) 106. Alternatively, one production site 104 and/or one dump site 106 may be part of more than one production circuit 102, such as when material from one production site 104 is used at more than one dump sites 106 and/or when the production at a dump site 106 requires material from more than one production site 104.

In some examples, each production circuit 102 may include a dedicated controller 110 that can monitor, control and/or relay information to or from assets, such as one or more machines 108, and/or other machines that may be operating within each particular production circuit 102. A central controller 112 may communicate with the various circuit controllers 110 to relay and exchange high-level information that pertains to the work environment 100 as a whole.

A production circuit 102 may include a sequence of activities to be performed by a machine 108 one or more times. An activity may include a unit of work performed by a machine 108. For example, an activity may include a travel time, a service, a fueling operation, and/or a charging operation, among other examples. Where a production circuit 102 is to be performed more than once, the production circuit 102 should start and end at the same location. For example, a production circuit 102 may include a simple circuit, e.g., starting at a loading tool of a production site 104, loading a machine 108 via the loading tool, traveling to a dump site 106, dumping at the dump site 106, and returning to the production site 104, a complex circuit, e.g., starting at a first loading tool of a first production site 104, loading a machine 108 via the first loading tool, traveling to a dump site 106, dumping at the dump site 106, traveling to a second loading tool of a second production site 104, loading the machine 108 via the second loading tool, traveling to a third production site 104, loading an additive material, such as lime, among other examples, to the load being carried by the machine 108, traveling to a second dump site 106, dumping at the second dump site 106, and returning to the first loading tool, a watering circuit, e.g., including one or more activities associated with watering roads or plan areas, a grading circuit, e.g., including one or more grading activities, a wheel loader circuit, e.g., including one or more loading and/or repair activities, and/or a compact track loader circuit, e.g., including one or more pallet loading or pallet dump activities, among other examples. Some activities may be repeated in a given production circuit 102. For example, a production circuit 102 may include a machine 108 loading and dumping twice and then travel to a charge station to charge.

As an example, each production circuit 102 may include at least one production site 104, which may be operated by one or more loaders 114. During operation, one or more machines 108 may arrive at the production site 104 for loading, for example at a position 116. A production queue 118 may stack incoming machines 108. A loaded machine 120 may travel a production arc 122 between the loading position 116 and a dump position 124 at the dump site 106. Loaded machines may similarly be stacked at a dump queue 126 while waiting to assume the dump position 124. Emptied machines 128 may travel a return arc 130 between the dump position 124 and the production queue 118 or the loading position 116 before repeating the production arc 122. This process, or a variant thereof, may be carried out in each of the production circuits 102 during operation.

The rate of material transfer from the production site 104 to the dump site 106 can be generally quantified and compared to a target production rate defined within a production plan for the production circuit 102. This production rate, from an asset engagement perspective, occupies a plurality of machines 108 that are assigned to, or engaged in, the particular production circuit 102 during operation. In a given production circuit 102, longer wait times of machines 108 in queues 118 and 126 can slow down the scheduled deliveries thereby reducing the overall production rate for the given production circuit 102. Moreover, the production plan at each production circuit 102, even if optimized at the beginning of the production cycle, requires re-optimization due to longer wait times in queues 118 and 126. As shown by reference number 132, a production plan and/or an updated production plan may be provided, e.g., from the controller 112 to one or more controllers 110, to address the changes in the work environment 100 and/or reach the target production rates. To accomplish this, in part, the number of machine 108 assignments to a given production circuit 102 may be changed, increased or decreased, based on the updated production plan. In general, the production plan defines the amount of material moved from one or more locations in the work environment 100 to one or more other locations in the work environment 100, which material movement can be expressed as a total tonnage of material over a period of time that is moved, or alternatively a rate of transfer of material in tons per hour, among other examples.

For example, one or more production circuits 102 may be based on respective production parameters, as defined by the production plan. A production parameter may refer to a rate of production of one or more machines 108 assigned to a given production circuit 102. For example, the one or more production circuits 102 may be based on respective production parameters in that a given production circuits 102 may be designed or configured, e.g., by a controller 110 and/or the controller 112, to optimize or improve production performance of the one or more machines 108 assigned to the given production circuit 102, e.g., as a function of the amount of material moved from one or more locations in the work environment 100 to one or more other locations in the work environment 100.

The production plan may be manually or automatically input into a production planner and can include information on the desired or target production for the work environment 100 on a daily basis, production goals for the mid-term or long-term operation, production types and timing of product delivery for the mine, scheduling, and other information relating directly to the desired type, and/or amount and timing of work environment output or production, among other examples. This information may be input by a user by defining various system parameters included in a software application that is operating within the production planner, or may alternatively be provided automatically, for example, by processing customer orders for material that are submitted by customers, for example, over an internet-based ordering system, among other examples.

As indicated above, FIG. 1 is provided as an example. Other examples may differ from what is described with regard to FIG. 1.

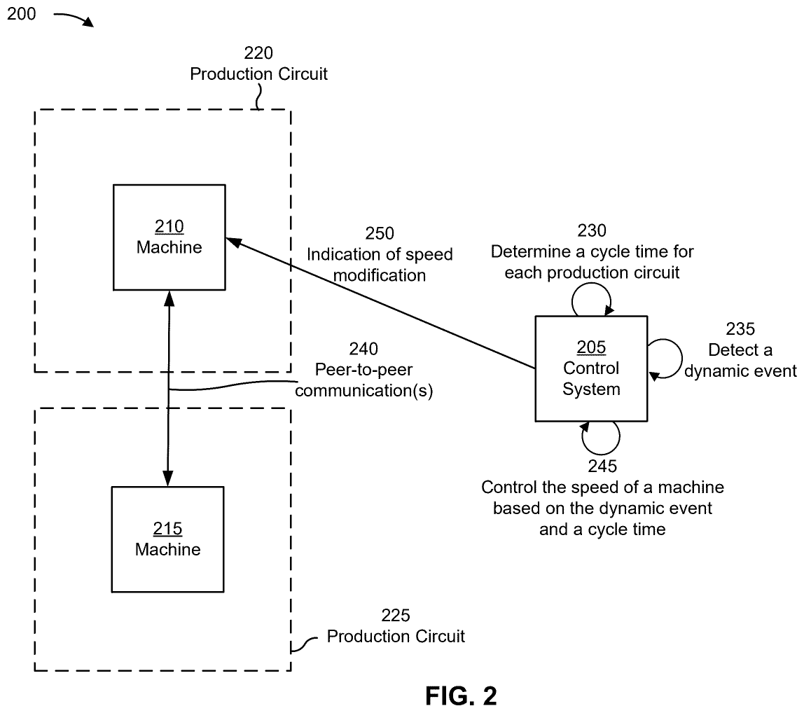

FIG. 2 is a diagram of an example 200 associated with machine speed management. As shown in FIG. 2, a control system 205 may perform one or more operations associated with machine speed management. For example, the control system 205 may control or manage a speed of one or more machines, e.g., machines 108, such as a machine 210 and a machine 215. Although FIG. 2 depicts two machines as an example, the control system 205 may control or manage a speed of any number of machines. In some examples, the machine 210 may be operating in a production circuit 220, e.g., a production circuit 102. The machine 215 may be operating in a production circuit 225, e.g., another production circuit 102. In other examples, the machine 210 and the machine 215 may be operating in the same production circuit 102.

As shown by reference number 230, the control system 205 may determine a cycle time for each production circuit 102, e.g., a first cycle time for the production circuit 220 and a second cycle time for the production circuit 225. For example, the control system 205 may determine cycle times for respective production circuits of the one or more production circuits 102. A cycle time may refer to an amount of time in which a machine 108 is expected to complete a given production circuit 102, e.g., an amount of time in which a machine 108 is expected to complete one or more activities or tasks defined or configured for the given production circuit 102. The cycle time may be a recommended amount of time or a target amount of time for a machine completing a given production circuit 102.

The control system 205 may determine a ranking or order of the one or more production circuits 102. For example, the control system 205 may determine a set of ranked production circuits. The control system 205 may determine the ranking or order based on an amount of work or number of activities associated with the one or more production circuits 102, a number of machines 108 assigned to the one or more production circuits 102, a length, e.g., in total distance to be traveled by the machines 108, associated with the one or more production circuits 102, among other examples. In some examples, the ranking or order of the one or more production circuits 102 may facilitate speed management determinations for machines in different production circuits 102, as described in more detail elsewhere herein.

Each production circuit 102, e.g., the production circuit 220 and/or the production circuit 225, may be associated with a cycle time and a recommended quantity of machines 108 assigned to that production circuit 102. The control system 205 may determine the cycle time for a production circuit 102 based on one or more performance parameters of the machines 108. For example, the control system 205 may determine the cycle time to improve a likelihood that a value of a performance parameter for a machine completing activities associated with a production circuit 102 satisfies one or more threshold and/or meets one or more criteria for a duration of the entire production circuit 102. For example, the cycle time may define a recommended, e.g., average, speed for a machine 108 operating in a given production circuit 102.

The one or more performance parameters may include a tire heat parameter, a battery level parameter, a battery usage efficiency parameter, a battery damage parameter, and/or a fuel efficiency parameter, among other examples. The tire heat parameter may be associated with a temperature of one or more tires of a machine. For example, the tire heat parameter may be a tonne-kilometres per hour (TKPH) or ton-miles per hour (TMPH) parameter. For example, the tire heat parameter may be an expression of a working capacity of a tire. The tire heat parameter may represent a load capacity of the tire in relation to heat generation. For example, the tire heat parameter may represents the amount of weight, e.g., in metric tonnes, a tire can carry over a distance of one kilometer within an hour, while still maintaining optimal performance and durability. This can be a representation of the temperature of the tire because the workload of a tire directly influences the amount of heat generated during operation. When a tire carries heavier loads or operates at higher speeds, the tire experiences increased friction with the road surface, which generates heat. Using the TKPH parameter, or TMPH parameter, may reduce the complexity of estimating or representing the temperature of the tires of a machine during operation. In other examples, the tire heat parameter may be a temperature of the tire(s) of a machine. For example, the machine may include one or more sensors or systems configured to measure the temperature of the tire. In some examples, a manufacturer of a tire may define a threshold or criteria for the tire heat parameter. The threshold or criteria may define a value that the tire heat parameter should not exceed to ensure performance and durability of the tire. For example, exceeding the threshold or criteria for the tire heat parameter during operation may void one or more warranties provided by the manufacturer.

The control system 205 may determine the cycle times for respective production circuits 102 based on, or using, the tire heat parameter. For example, the control system 205 may determine an amount of work to be performed by a machine for one or more activities defined or configured for a given production circuit 102, e.g., a total weight of material to be moved by the machine during for one or more activities. The control system 205 may determine a distance to be traveled by the machine to complete the given production circuit 102. The control system 205 may determine a target value for the tire heat parameter. Based on the amount of work, the total distance, and the target value of the tire heat parameter, the control system 205 may determine an amount of time in which the machine should complete the given production circuit 102, e.g., to ensure that the target value of the tire heat parameter is not exceeded when operating in the production circuit 102. This may increase a likelihood that a machine is able to complete the production circuit 102 in the least amount of time without exceeding the target value of the tire heat parameter, thereby increasing the productivity and/or efficiency of the machine while also ensuring the temperature of the tires of the machine remain within safe operating levels. The control system 205 may determine cycle times for each production circuit 102, e.g., for the production circuit 220 and/or the production circuit 225, in a similar manner.

Additionally, or alternatively, the control system 205 may determine the cycle times for respective production circuits 102 based on, or using, the battery level parameter. The battery level parameter may represent a target or recommended battery level for one or more batteries of a machine completing a given production circuit 102, e.g., taking into account one or more charging operations included in the production circuit 102. For example, traveling at higher speeds, e.g., when loaded, may cause a machine to consume additional energy of the battery. Therefore the control system 205 may determine the cycle times for respective production circuits 102 based on the amount of work for a given production circuit 102, the total distance of the given production circuit 102, and a target value of battery level parameter.

Additionally, or alternatively, the control system 205 may determine the cycle times for respective production circuits 102 based on, or using, the battery damage parameter. The battery damage parameter may be a measure of a condition or health of a battery. For example, the battery damage parameter may include a capacity loss, an internal resistance, a cycle lift, a state of health (SoH), a state of charge (SoC), a temperate sensitivity, and/or a voltage fade, among other examples. The control system 205 may determine the cycle times for respective production circuits 102 to improve a likelihood that a target value for the battery damage parameter is not exceeded by a machine completing the respective production circuits 102.

Additionally, or alternatively, the control system 205 may determine the cycle times for respective production circuits 102 based on, or using, the battery usage efficiency parameter. The battery usage efficiency parameter may be a measure of an effectiveness with which a battery converts stored chemical energy into electrical energy during a discharge cycle, e.g., quantifying how efficiently the battery can deliver the energy stored by the battery. The control system 205 may determine the cycle times for respective production circuits 102 to improve a likelihood that a target value for the battery usage efficiency parameter is satisfied by a machine completing the respective production circuits 102. Additionally, or alternatively, the control system 205 may determine the cycle times for respective production circuits 102 based on, or using, the fuel efficiency parameter, e.g., for machines configured to use a fuel, such as gasoline. For example, traveling at higher speeds, e.g., when loaded, and/or over longer distances may cause a machine to consume additional fuel. The control system 205 may determine the cycle times for respective production circuits 102 to improve a likelihood that a target value for the fuel efficiency parameter is satisfied by a machine completing the respective production circuits 102.

The control system 205 may configure the cycles times for respective production circuits 102 as part of the production plan. For example, the control system 205 may configure a first cycle time for the first production circuit 220 and a second cycle time for the second production circuit 225. The control system 205 may perform one or more operations to cause the machine 210 to travel at one or more speeds that result in the machine 210 completing the production circuit 220 within a variance of the first cycle time, e.g., plus or minus a variance from the first cycle time. Similarly, the control system 205 may perform one or more operations to cause the machine 215 to travel at one or more speeds that result in the machine 215 completing the production circuit 225 within a variance of the second cycle time, e.g., plus or minus a variance from the second cycle time.

The variance may be a value, such as X seconds or minutes. In such examples, completing a production circuit within a variance of the cycle time may refer to completing the production circuit within plus or minus X seconds or minutes of the cycle time. As another example, the variance may be a percentage of a cycle time. In some examples, the variance may be a low variance. In other words, the variance may be a value or percentage that is associated with causing machines to complete the production circuit close to, or near, the cycle time for the production circuit.

In some examples, the control system 205 may control the speed of the machines to cause the machines to complete the production circuits within a variance of the configured cycle times, such as where the machines are autonomously or semi-autonomously controlled. As another example, the control system 205 may provide an operator notification of a recommended speed, e.g., via an operator display for a given machine, indicating the recommended speed to cause the given machine to complete a production circuit 102 in which the given machine is operating within a variance of the configured cycle time for the production circuit 102.

As shown by reference number 235, the control system 205 may detect a dynamic event. The dynamic event may be associated with a given machine, such as the machine 210 or the machine 215. The dynamic event may occur in the work environment 100. For example, a dynamic event may be an event associated with an operation of a given machine. The dynamic event may be associated with modifying or changing a speed at which the given machine is traveling. As described herein, the control system 205 may perform an action associated with controlling a speed of a machine, e.g., the machine 210, based on a cycle time of the production circuit 220, e.g., in which the machine 210 is operating, and based on one or more dynamic events in the work environment.

A dynamic event may include the machine 210 traveling on a portion of the production circuit 220 that is shared by, or is common to, one or more other production circuits, such as the production circuit 225. For example, the portion of the production circuit 220 may include one or more shared roads with another production circuit, such as the production circuit 225. The control system 205 may determine that the production circuit 225 has a cycle time which may result in the machine 215 traveling at a faster average speed than the average speed of the machine 210. Therefore, the control system 205 may determine that the machine 210 should increase speed on the portion of the production circuit 220. This may reduce the likelihood that a machine, such as the machine 215, operating in the production circuit 225 will have to slow down due to the machine 210 traveling at a lower, such as an average, speed. As a result, a likelihood of reducing the productivity or efficiency of the machine, such as the machine 215, may be reduced.

As an example, a dynamic event may include the machine 210 being in proximity to another machine, e.g., the machine 215, that is traveling at a different speed, e.g., on a shared road or track. For example, the dynamic event may include the machine 210 and the machine 215 traveling on a shared road, e.g., that is used for both the production circuit 220 and the production circuit 225. The control system 205, and/or the machine 210 or the machine 215, may detect that the machine 210 is traveling at a first speed and the machine 215 is traveling at a second speed which may result in a slow down event for one of the machine 210 or the machine 215, e.g., because of the differences in speed and the proximity of the machines, one of the machine 210 or the machine 215 may need to reduce speed to avoid a collision. For example, the first speed may be greater than the second speed and the machine 210 may be behind the machine 215 on the shared road. As another example, the second speed may be greater than the first speed and the machine 210 may be in front of the machine 215 on the shared road. As a result, the control system 205, and/or the machine 210 or the machine 215, may detect the dynamic event. For example, the dynamic event may be associated with one of the machine 210 or the machine 215 changing speeds.

For example, the control system 205 may detect that the machine 215 is traveling at the second speed in the portion of the production circuit 225 that is shared with the production circuit 220. The control system 205 may detect the difference in speed and/or the proximity of the machine 210 and the machine 215 using sensor data from the machine 210 and/or the machine 215. Additionally, or alternatively, the control system 205 may detect the difference in speed and/or the proximity of the machine 210 and the machine 215 using tracking data, such as data obtained via a system configured to monitor or track a location and/or speed of machines in the work environment 100, e.g., a global positioning system (GPS).

As shown by reference number 240, the control system 205 may detect the difference in speed and/or the proximity of the machine 210 and the machine 215 based on one or more peer-to-peer communications, e.g., based on a content or information exchanged as part of the one or more peer-to-peer communications. The one or more peer-to-peer communications may include one or more wired and/or wireless communications. In some examples, the one or more peer-to-peer communications may include wireless wide area network communications, e.g., a cellular network or a public land mobile network communications, local area network communications, e.g., a wired local area network or a wireless local area network (WLAN) communications, such as a Wi-Fi network communications, personal area network communications, e.g., a Bluetooth network communications, near-field communication network communications, telephone network communications, private network communications, vehicle-to-vehicle (V2V) communications, e.g., cellular vehicle-to-everything (V2X) communications, mesh network communications, and/or a combination of these or other types of communications.

The machine 215 may detect that the machine 215 is traveling at a faster speed than the machine 210 and that a distance between the machine 210 and the machine 215 is less than or equal to a proximity threshold, e.g., that the machine 210 and the machine 215 are within a proximity of each other. In such examples, the machine 215 may transmit, and the machine 210 may receive, a request to increase the speed of the machine 210. The machine 210, and/or the control system 205, may determine whether the speed of the machine 210 can be increased, e.g., based on a current operating state of the machine, such as current values of the one or more performance parameters. For example, if increasing the speed of the machine 210 would cause a value of a performance parameter to exceed a threshold or not meet a criteria, then the machine 210, and/or the control system 205, may determine that the speed of the machine 210 cannot be increased. If increasing the speed of the machine 210 would not cause a value of a performance parameter to exceed a threshold or not meet a criteria, then the machine 210, and/or the control system 205, may determine that the speed of the machine 210 can be increased. The machine 210 may transmit, and the machine 215 may receive, a response indicating whether the speed of the machine 210 can be increased. In other words, the one or more peer-to-peer communications may indicate the dynamic event. Additionally, or alternatively, the machine 210 and the machine 215 may negotiate, e.g., via the one or more peer-to-peer communications, a speed at which the two machines are to travel on the shared portion of the production circuit 220 and the production circuit 225.

In some examples, the control system 205 may determine which machine is to change speeds based on the order or ranking of production circuits. For example, the order or ranking of production circuits may indicate priorities of respective production circuits 102. The control system 205 may determine that the machine which is operating in the lower priority production circuit, e.g., as indicated by the order or ranking of production circuits, is to change speed. As another example, the control system 205 may determine that the machine that is traveling at the slower speed is to change speed, e.g., to reduce a likelihood of reducing the productivity or efficiency of the machine which is able to travel at the faster speed.

In some examples, the dynamic event may include a battery charging event. As an example, the control system 205 may determine that a predicted cycle time for the machine 210 in the production circuit 220 is different than the cycle time when a distance between the machine 210 and a charging station satisfies a threshold. The control system 205 may cause, based on determining that the predicted cycle time for the machine 210 in the production circuit 220 is different than the cycle time, the machine 210 to perform the battery charging event, e.g., a charging operation, at the charging station. The control system 205 may cause, after the machine 210 departs the charging station, the speed of the machine 210 to be modified based on the cycle time of the production circuit 220. In other words, if the control system 205 determines that the machine 210 is ahead of schedule, e.g., is predicted to finish the production circuit 220 before the cycle time of the production circuit 220, and the machine 210 is near a charging station, then the control system 205 may cause, or recommend, that the machine 210 stop to charge at the charging station. This may be referred to as opportunistic charging. The opportunistic charging may improve a battery level of the machine 210 and provide a more battery efficient manner to cause the machine 210 to complete the production circuit 220 within a tolerance of the cycle time, e.g., as compared to simply slowing down the speed of the machine 210.

As another example, the battery charging event may be associated with a battery level of the machine 210 being less than or equal to a threshold. Based on the battery level of the machine 210 being less than or equal to the threshold, the control system 205 may cause the machine 210 to stop at a charging station to charge the battery of the machine 210. Based on the machine 210 stopping at the charging station, the control system 205 may determine that a speed of the machine 210 can be increased, e.g., above an average speed as indicated by the cycle time for the production circuit 220. This may enable the machine 210 to complete the production circuit 220 within a variance of the cycle time while also enabling the machine 210 to charge the battery. This may improve a productivity and/or efficiency of the machine 210 when the battery charging event occurs.

As shown by reference number 245, the control system 205 may control a speed of a machine, e.g., the machine 210, based on the dynamic event and the cycle time of a production circuit, as described herein. The control system 205 may cause the speed of the machine 210 to be modified, e.g., when the machine 210 is an autonomous vehicle that is controlled via the control system 205. As another example, the control system 205 may provide, for display or output, a notification of a suggested or recommended speed for the machine 210, e.g., when the machine 210 is a semi-autonomous or is operator controlled.

For example, as shown by reference number 250, the control system 205 may perform an action associated with modifying a speed of the machine 210, e.g., from the average speed indicated by the cycle time of the production circuit 220. The control system 205 may transmit or provide, and the machine 210 may receive or obtain, the indication of the speed modification, e.g., indicating the speed at which the machine 210 is to travel.

For example, the control system 205 may cause the machine 210 to travel at a first speed in a first portion of the production circuit 220 based on the one or more dynamic events. The control system 205 may cause the machine 210 to travel at a second speed in a second portion of the production circuit 220 to cause the machine 210 to complete the production circuit 220 within a variance of the cycle time of the production circuit 220. As described above, the first portion of the production circuit 220 may include one or more shared roads with the production circuit 225.

As an example, the control system 205 may detect that the machine 210 is traveling at a third speed in the first portion of the first production circuit, e.g., before modifying or recommending the modification of the speed of the machine 210. The control system 205 may detect that machine 215 is traveling in the first portion of the production circuit 220 at approximately the first speed, e.g., within a variance of the first speed. The control system 205 may detect that a distance between the machine 210 and the machine 215 satisfies a proximity threshold. Therefore, the control system 205 may modify the speed of the machine 210 from the third speed to the first speed based on detecting that the machine 215 is traveling in the first portion of the production circuit 220, e.g., behind the machine 210, at approximately the first speed. In other words, the control system 205 may cause the machine 210 to increase speed to reduce a likelihood of bunching on shared roads between production circuits.

The control system 205 may cause the machine 210 to reduce speed on other portion(s) of the production circuit 220 to cause the machine 210 to complete the production circuit 220 within a variance of the cycle time of the production circuit 220. For example, the control system 205 may modify the speed of the machine 210 to a first modified speed based on detecting that the difference between the speed of the machine 210 and the speed of the machine 215 satisfies the speed threshold. The first updated speed may be based on the speed of the machine 215, e.g., may be the speed of the machine 215 or may be greater than the speed of the machine 215, and/or may be based on the one or more peer-to-peer communications. The control system 205 may modify the speed of the machine 210 to a second modified speed based on an updated distance between the machine 210 and the machine 215 not satisfying the proximity threshold. The second updated speed may be based on the cycle time of the production circuit 220, e.g., the second updated speed may be configured to cause the machine 210 to complete the production circuit 220 within a variance of the cycle time.

In some implementations, the control system 205 may use one or more machine learning operations to determine recommended speeds for the machine 210 on different portions of the production circuit 220. For example, the control system 205 may use heuristics, stochastic modelling, simulation, or machine learning could be used to determine optimal speeds with the objective to achieve the cycle times for each execution of the defined production circuits. For example, the one or more machine learning operations may enable the control system 205 when to reduce the speed or increase the speed of the machine 210 in different portions of the production circuit 220.

As another example, the control system 205 may determine that a predicted cycle time of the machine 210 is greater than the cycle time of the production circuit 220. For example, the machine 210 may encounter more delays or stoppages, e.g., due to stops at intersections, referred to as an intersection event, or queues at stations, referred to as a load time event, that slow down the machine 210. The control system 205 may cause, or recommend, the machine 210 to increase speed to complete the production circuit 220 within a variance of the cycle time. This may improve a productivity and/or efficiency of the machine 210.

In some examples, the control system 205 may be included in the machine 210. For example, the control system 205 may be an on-board system. In other examples, the control system 205 may not be included in the machine 210, e.g., the control system 205 may be a remote system. For example, the control system 205 may be included in an on-premise device, e.g., a server device, and/or may be deployed in a cloud computing environment. In some examples, the control system 205 may be partially included in the machine 210 and partially included remote from the machine 210, e.g., the control system 205 may include one or more controllers included in the machine 210 and one or more controllers remote from the machine 210.

The control system 205 may include one or more controllers, such as the controller 112 and/or one or more controllers 110. The control system 205 may include a central processing unit, a graphics processing unit, a microprocessor, a controller, a microcontroller, a digital signal processor, a field-programmable gate array, an application-specific integrated circuit, and/or another type of processing component. The control system 205 may be implemented in hardware, firmware, or a combination of hardware and software. In some implementations, the control system 205 may include one or more processors capable of being programmed to perform one or more operations or processes described elsewhere herein.

In some examples, the control system 205 may include one or more memories. A memory may include volatile and/or nonvolatile memory. For example, the memory may include random access memory (RAM), read only memory (ROM), a hard disk drive, and/or another type of memory, e.g., a flash memory, a magnetic memory, and/or an optical memory. The memory may include internal memory, e.g., RAM, ROM, or a hard disk drive, and/or removable memory, e.g., removable via a universal serial bus connection. The memory may be a non-transitory computer-readable medium. The memory may store information, one or more instructions, and/or software, e.g., one or more software applications, related to the operation of the control system 205. In some implementations, the memory may include one or more memories that are coupled, e.g., communicatively coupled, to one or more processors, e.g., processor, such as via a bus. Communicative coupling between a processor, or controller, and a memory may enable the processor, or controller, to read and/or process information stored in the memory and/or to store information in the memory.

The control system 205 may perform one or more operations or processes described herein. For example, a non-transitory computer-readable medium, e.g., memory, may store a set of instructions, e.g., one or more instructions or code, for execution by one or more processors or controllers. The processor or controller may execute the set of instructions to perform one or more operations or processes described herein. In some implementations, execution of the set of instructions, by one or more processors or controllers, causes the one or more processors or controllers and/or the control system 205 to perform one or more operations or processes described herein. In some implementations, hardwired circuitry may be used instead of or in combination with the instructions to perform one or more operations or processes described herein. Additionally, or alternatively, the control system 205 may be configured to perform one or more operations or processes described herein. Thus, implementations described herein are not limited to any specific combination of hardware circuitry and software.

As indicated above, FIG. 2 is provided as an example. Other examples may differ from what is described with regard to FIG. 2.

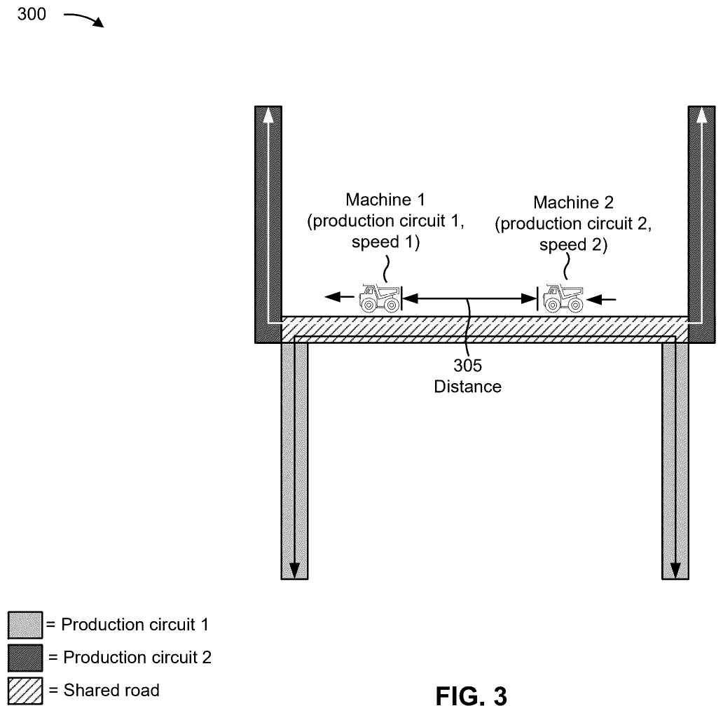

FIG. 3 is a diagram of an example associated with a dynamic event 300. FIG. 3 depicts an example dynamic event 300 associated with bunching on a shared road between two, or more, production circuits, shown as production circuit 1 and production circuit 2 in FIG. 3. Other dynamic events are described elsewhere herein. The production circuit 1 may be the production circuit 220 and the production circuit 2 may be the production circuit 225.

As shown in FIG. 3, a first machine, shown as machine 1, may be operating in the production circuit 1. For example, the first machine may be the machine 210. The first machine may be traveling at a first speed, shown as speed 1. A second machine, shown as machine 2, may be operating in the production circuit 2. For example, the second machine may be the machine 215. The second machine may be traveling at a second speed, shown as speed 2.

The first machine and the second machine may be traveling on a shared road, e.g., that is part of both the production circuit 1 and the production circuit 2. The first machine may be in front of the second machine on the shared road, e.g., relative to a direction of travel of both the first machine and the second machine. The first speed may be less than the second speed. In other words, the second machine may be traveling faster than the first machine. The first machine and the second machine may be separated by a distance 305.

The dynamic event 300 may be associated with the difference of speed of the first machine and the second machine, the distance 305, and/or a remaining distance on the shared road for the first machine. For example, the dynamic event 300 may be associated with the difference of speed of the first machine and the second machine satisfying a speed threshold and/or the distance 305 satisfying a proximity threshold. In some examples, the dynamic event 300 may be associated with difference of speed of the first machine and the second machine and the distance 305 indicating that the second machine will have to slow down or will collide with the first machine before the first machine exits the shared road, e.g., based on the remaining distance on the shared road for the first machine.

As described elsewhere herein, the control system 205 may cause the first machine to increase speed, e.g., from the first speed, on the shared road, e.g., to reduce a likelihood that the second machine will need to reduce speed or collide with the first machine. As described elsewhere herein, the control system 205 may cause the first machine to reduce speed, e.g., from the increased speed, on other portions of the production circuit 1, e.g., to cause the first machine to complete the production circuit 1 within a variance of the cycle time of the production circuit 1.

As indicated above, FIG. 3 is provided as an example. Other examples may differ from what is described with regard to FIG. 3.

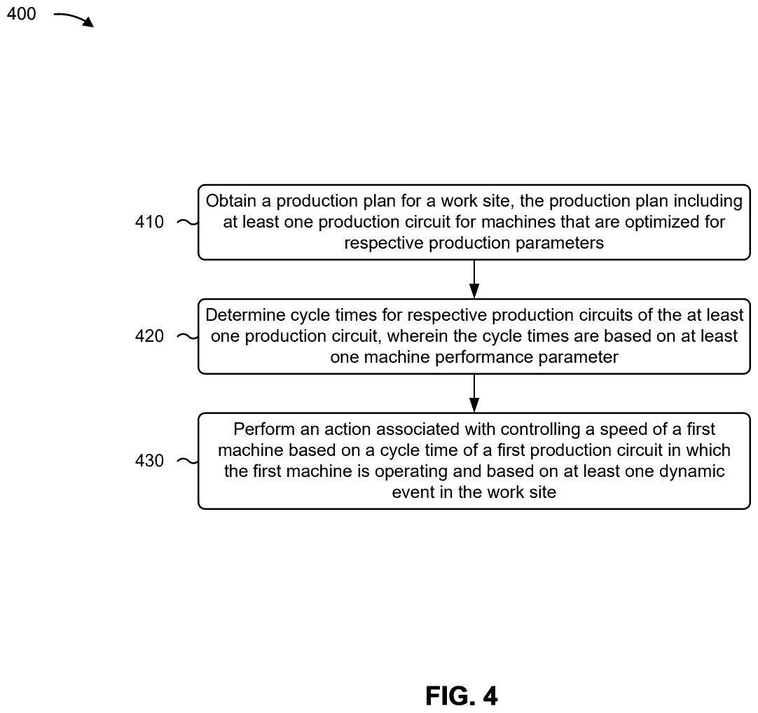

FIG. 4 is a flowchart of an example process 400 associated with machine speed management. One or more process blocks of FIG. 4 may be performed by a control system, e.g., control system 205. Additionally, or alternatively, one or more process blocks of FIG. 4 may be performed by another device or a group of devices separate from or including the control system, such as another device or component that is internal or external to a machine, such as the machine 210.

As shown in FIG. 4, process 400 may include obtaining a production plan for a work environment, the production plan including at least one production circuit for machines, wherein the at least one production circuit is based on respective production parameters (block 410). For example, the control system may obtain a production plan for a work environment, the production plan including at least one production circuit for machines, wherein the at least one production circuit is based on respective production parameters, as described above.

As further shown in FIG. 4, process 400 may include determining cycle times for respective production circuits of the at least one production circuit, wherein the cycle times are based on at least one machine performance parameter (block 420). For example, the control system may determine cycle times for respective production circuits of the at least one production circuit, wherein the cycle times are based on at least one machine performance parameter, as described above.

As further shown in FIG. 4, process 400 may include performing an action associated with controlling a speed of a first machine based on a cycle time of a first production circuit in which the first machine is operating and based on at least one dynamic event in the work environment (block 430). For example, the control system may perform an action associated with controlling a speed of a first machine based on a cycle time of a first production circuit in which the first machine is operating and based on at least one dynamic event in the work environment, as described above. The action may include providing, for display or output, a notification of a suggested speed for the first machine. In some implementations, the at least one dynamic event includes at least one of a road intersection event, a tire heat event, a load time event, or a low battery event.

In some implementations, performing the action includes causing the first machine to travel at a first speed in a first portion of the first production circuit based on the at least one dynamic event, and causing the first machine to travel at a second speed in a second portion of the first production circuit to cause the first machine to complete the first production circuit within a variance of the cycle time.

In some implementations, causing the first machine to travel at the first speed includes detecting that the first machine is traveling at a third speed in the first portion of the first production circuit, detecting that a second machine is traveling in the first portion of the first production circuit at approximately the first speed, where a distance between the first machine and the second machine satisfies a proximity threshold, and modifying the speed of the first machine from the third speed to the first speed based on detecting that the second machine is traveling in the first portion of the first production circuit at approximately the first speed.

In some implementations, detecting that the second machine is traveling in the first portion of the first production circuit at approximately the first speed comprises detecting, via peer-to-peer communication between the first machine and the second machine, that the second machine is traveling at approximately the first speed.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

### INDUSTRIAL APPLICABILITY

In some examples, machine speed may be managed to ensure that the one or more parameters are satisfied or met. For example, machine speed may be managed for particular machines, e.g., on a per-machine basis. This per-machine basis speed management result in inefficient operation for the other machines and/or the work environment as a whole. For example, while reducing the speed of a given machine may ensure that the one or more parameters are met or satisfied for that machine, this may result in reducing a speed of other machines that are traveling behind the machine where the other machines could otherwise be traveling at a faster speed. The reduction in speed of the machine machines may reduce the production and/or efficiency of the entire work environment, e.g., may reduce a productivity of an entire mining site.

In other examples, machine speed may be managed in a centralized manner using an assignment operation. The assignment operation may include determinations of a next task for a given machine based on a current operating state of the given machine, e.g., taking into account current values for the one or more parameters, such as a current tire temperature of the given machine. However, this machine speed management mechanism is reactive to the current operating state of the machines and may only take action to address values of the one or more parameters until after the values are at, or near, threshold or other criteria for the one or more parameters. As a result, a production efficiency of the machines may be reduced because the assignment operation may only be for a next task which may result in a given machine being placed in an operating state where there are no effective or efficient options for tasks for the machine, such as due to an amount of work done by the machine causing an increase in tire heat of the machine, e.g., resulting in the machine having to be out of operation or traveling at very low speeds to reduce the tire heat. Further, the assignment operation may use large amounts of data, e.g., real-time data or near real-time data, increasing the complexity and/or consuming processing resources, computing resources, and/or memory resources, among other examples, associated with performing the assignment operation.

Some implementations described herein enable enhanced machine speed management. For example, the control system described herein may use production circuits, e.g., designed or configured to improve productivity of machines, and cycle times, e.g., defined using one or more performance parameters, to manage or control the speed of a given machine. Additionally, the control system may use dynamic events to adjust the speed of the machine, e.g., based on, or in response to, the dynamic events. For example, the cycle time may define a recommended, or average, speed for the machine when operating in the production circuit. However, the control system may modify a speed of the machine based on, or in response to, the dynamic events.

This multi-layered machine speed management enables a given machine to adjust to dynamic and/or real time events as they occur in a work environment while also increasing a likelihood that a machine is able to complete the production circuit in the least amount of time without exceeding target values of respective performance parameters. As a result, the control system may increase the productivity and/or efficiency of the machine while also ensuring the value(s) of the performance parameters of the machine remain within safe operating levels. For example, by causing the machine to adjust speed to complete the production circuit within a variance of a cycle time for the production circuit, a productivity and/or efficiency of the machine may be improved, e.g., because the machine may complete the production circuit in less time. Further, by configuring or defining the cycle time based on the one or more performance parameters, a likelihood of a value of a given performance parameter exceeding a threshold or not meeting a criteria may be reduced. This may reduce the likelihood of damage to one or more components of the machine, such as a tire or a battery, among other examples. Additionally, by reducing the likelihood of a value of a given performance parameter exceeding the threshold or not meeting the criteria, a likelihood that the component(s) of the machine operating within bounds defined by a manufacturer may be increased, e.g., reducing the likelihood of damage to the component(s) and/or reducing the likelihood of voiding warranties of respective components.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

When “a processor” or “one or more processors,” or another device or component, such as “a controller” or “one or more controllers,” is described or claimed, within a single claim or across multiple claims, as performing multiple operations or being configured to perform multiple operations, this language is intended to broadly cover a variety of processor architectures and environments. For example, unless explicitly claimed otherwise, e.g., via the use of “first processor” and “second processor” or other language that differentiates processors in the claims, this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more, possibly different, processors configured to perform Y; and one or more, also possibly different, processors configured to perform Z.”

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. As used herein, “at least one” may be used interchangeably with “one or more.” Also, as used herein, the term “or” is intended to be inclusive when used in a series and may be used interchangeably with “and/or,” unless explicitly stated otherwise, e.g., if used in combination with “either” or “only one of”.

What is claimed is:

1. A system for managing machine speed, comprising:
at least one controller configured to:
obtain a production plan for a work environment, the production plan including at least one production circuit for machines, wherein the at least one production circuit is based on respective production parameters;
determine cycle times for respective production circuits of the at least one production circuit, wherein the cycle times are based on at least one machine performance parameter; and
perform an action associated with controlling a speed of a first machine based on a cycle time of a first production circuit in which the first machine is operating and based on at least one dynamic event in the work environment.

2. The system of claim 1, wherein the at least one controller, to perform the action, is configured to:
cause the speed of the first machine to be modified.

3. The system of claim 1, wherein the at least one controller, to perform the action, is configured to:
cause the first machine to travel at a first speed in a first portion of the first production circuit based on the at least one dynamic event; and
cause the first machine to travel at a second speed in a second portion of the first production circuit to cause the first machine to complete the first production circuit within a variance of the cycle time.

4. The system of claim 3, wherein the first portion of the first production circuit includes at least one shared road with a second production circuit.

5. The system of claim 3, wherein the at least one controller, to cause the first machine to travel at the first speed, is configured to:
detect that the first machine is traveling at a third speed in the first portion of the first production circuit,
detect that a second machine is traveling in the first portion of the first production circuit at approximately the first speed,
wherein a distance between the first machine and the second machine satisfies a proximity threshold; and
modify the speed of the first machine from the third speed to the first speed based on detecting that the second machine is traveling in the first portion of the first production circuit at approximately the first speed.

6. The system of claim 1, wherein the at least one dynamic event includes a battery charging event, and wherein the at least one controller, to perform the action, is configured to:
determine that a predicted cycle time for the first machine in the first production circuit is different than the cycle time when a distance between the first machine and a charging station satisfies a threshold;
cause, based on determining that the predicted cycle time for the first machine in the first production circuit is different than the cycle time, the first machine to perform the battery charging event at the charging station; and
cause, after the first machine departs the charging station, the speed of the first machine to be modified based on the cycle time.

7. The system of claim 1, wherein the at least one dynamic event includes at least one peer-to-peer communication between the first machine and at least one other machine indicating that the speed of the first machine is to be modified.

8. The system of claim 1, wherein the system is included in the first machine.

9. The system of claim 1, wherein the at least one controller is further configured to:
detect that a difference between the speed of the first machine and another speed of a second machine satisfies a speed threshold,
wherein a distance between the first machine and the second machine satisfies a proximity threshold; and
wherein the at least one controller, to perform the action, is configured to:
modify the speed of the first machine to a first modified speed based on detecting that the difference between the speed of the first machine and the other speed of the second machine satisfies the speed threshold; and
modify the speed of the first machine to a second modified speed based on an updated distance between the first machine and the second machine not satisfying the proximity threshold,
wherein the first modified speed is based on the other speed of the second machine, and
wherein the second modified speed is based on the cycle time.

10. The system of claim 1, wherein the at least one machine performance parameter includes at least one of:
a tire heat parameter,
a battery level parameter,
a battery usage efficiency parameter,
a battery damage parameter, or
a fuel efficiency parameter.

11. A method for managing machine speed, comprising:
obtaining, by a controller, a production plan for a work environment, the production plan including at least one production circuit for machines, wherein the at least one production circuit is based on respective production parameters;
determining, by the controller, cycle times for respective production circuits of the o at least one production circuit, wherein the cycle times are based on at least one machine performance parameter; and
performing, by the controller, an action associated with controlling a speed of a first machine based on a cycle time of a first production circuit in which the first machine is operating and based on at least one dynamic event in the work environment.

12. The method of claim 11, wherein performing the action comprises:
providing, for display or output, a notification of a suggested speed for the first machine.

13. The method of claim 11, wherein performing the action comprises:
causing the first machine to travel at a first speed in a first portion of the first production circuit based on the at least one dynamic event; and
causing the first machine to travel at a second speed in a second portion of the first production circuit to cause the first machine to complete the first production circuit within a variance of the cycle time.

14. The method of claim 13, wherein causing the first machine to travel at the first speed comprises:
detecting that the first machine is traveling at a third speed in the first portion of the first production circuit,
detecting that a second machine is traveling in the first portion of the first production circuit at approximately the first speed,
wherein a distance between the first machine and the second machine satisfies a proximity threshold; and
modifying the speed of the first machine from the third speed to the first speed based on detecting that the second machine is traveling in the first portion of the first production circuit at approximately the first speed.

15. The method of claim 14, wherein detecting that the second machine is traveling in the first portion of the first production circuit at approximately the first speed comprises:
detecting, via peer-to-peer communication between the first machine and the second machine, that the second machine is traveling at approximately the first speed.

16. The method of claim 11, wherein the at least one dynamic event includes at least one of:
a road intersection event,
a tire heat event,
a load time event, or
a low battery event.

17. The method of claim 11, wherein the at least one machine performance parameter includes a tire heat parameter.

18. A non-transitory computer-readable medium storing a set of instructions, the set of instructions comprising:
at least one instruction that, when executed by at least one processor of a controller, cause the controller to:
obtain a production plan for a work environment, the production plan including at least one production circuit for machines, wherein the at least one production circuit is based on respective production parameters;
determine cycle times for respective production circuits of the at least one production circuit, wherein the cycle times are based on at least one machine performance parameter; and
perform an action associated with controlling a speed of a first machine based on a cycle time of a first production circuit in which the first machine is operating and based on at least one dynamic event in the work environment.

19. The non-transitory computer-readable medium of claim 18, wherein the at least one instruction, that cause the controller to perform the action, causes the controller to:
cause the first machine to travel at a first speed in a first portion of the first production circuit based on the at least one dynamic event; and
cause the first machine to travel at a second speed in a second portion of the first production circuit to cause the first machine to complete the first production circuit within a variance of the cycle time.

20. The non-transitory computer-readable medium of claim 18, wherein the at least one dynamic event includes at least one peer-to-peer communication between the first machine and one or more other machines indicating that the speed of the first machine is to be modified.
